(19) United States
(12) Patent Application Publication
(10) Pub. No.: US 2018/0153322 A1
(43) Pub. Date: Jun. 7, 2018

(54) Removable Bottom Cup

(71) Applicant: Robert Stuart, Overland Park, KS (US)

(72) Inventor: Robert Stuart, Overland Park, KS (US)

(21) Appl. No.: 15/366,713

(22) Filed: Dec. 1, 2016

(51) Int. Cl. A47G 19/22; B65D 81/36; B65D 8/00; G10K 11/08

(52) U.S. Cl. CPC A47G 19/2227; B65D 81/365; A47G 2200/143; G10K 11/08; B65D 11/02

(57) ABSTRACT

A removable bottom cup for dual use as a megaphone includes an annular wall that extends from a bottom to a top. The top is open. A plurality of perforations is positioned in the bottom. The perforations are interconnected and define a removable section of the bottom. A tab is flexibly coupled to a lower face of the removable section. The bottom and the annular wall define a vessel that is configured to position a consumable item. The tab is configured to position transverse to the removable section so that the tab is configured to grasp and pull. The perforations are configured to separate so that the removable section is detached from the bottom. The vessel is reconfigured to use as a megaphone.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to cups and more particularly pertains to a new cup for dual use as a megaphone.

### BRIEF SUMMARY OF THE INVENTION

An embodiment of the disclosure meets the needs presented above by generally comprising an annular wall that extends from a bottom to a top. The top is open. A plurality of perforations is positioned in the bottom. The perforations are interconnected and define a removable section of the bottom. A tab is flexibly coupled to a lower face of the removable section. The bottom and the annular wall define a vessel that is configured to position a consumable item. The tab is configured to position transverse to the removable section so that the tab is configured to grasp and pull. The perforations are configured to separate so that the removable section is detached from the bottom. The vessel is reconfigured to use as a megaphone.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a removable bottom cup according to an embodiment of the disclosure.

FIG. 2 is a side view of an embodiment of the disclosure.

FIG. 3 is an isometric perspective view of an embodiment of the disclosure.

FIG. 4 is an isometric perspective view of an embodiment of the disclosure.

FIG. 5 is a cross-sectional view of an embodiment of the disclosure.

FIG. 6 is an in-use view of an embodiment of the disclosure.

### DETAILED DESCRIPTION OF THE INVENTION

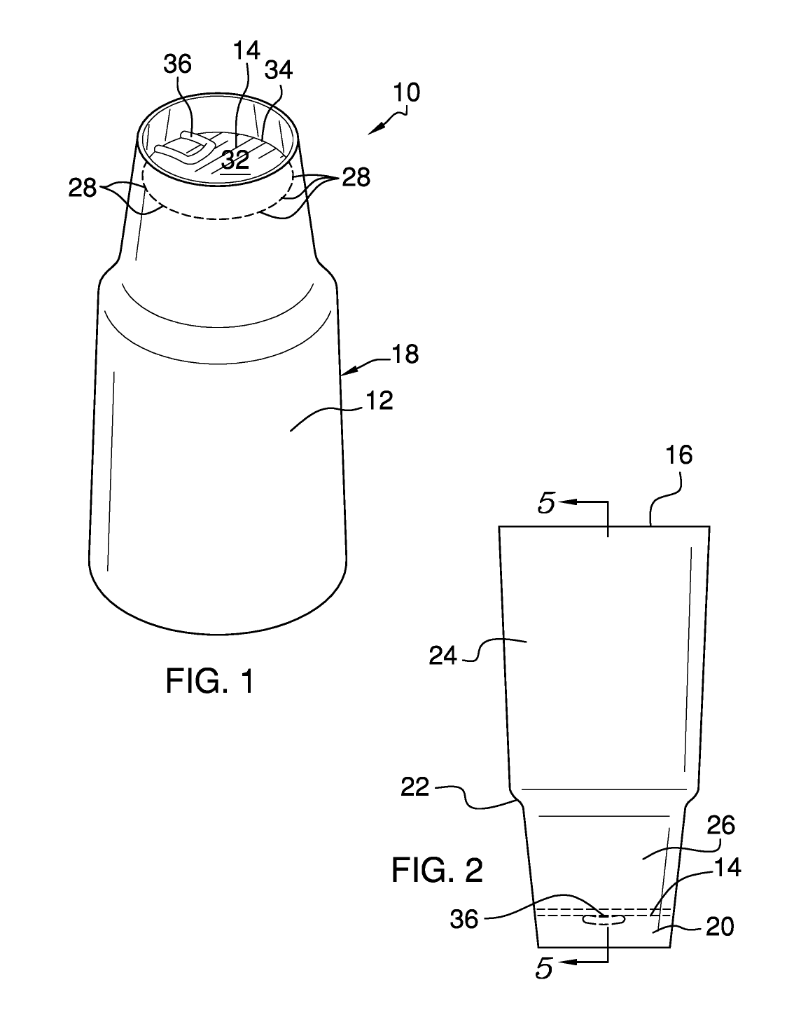

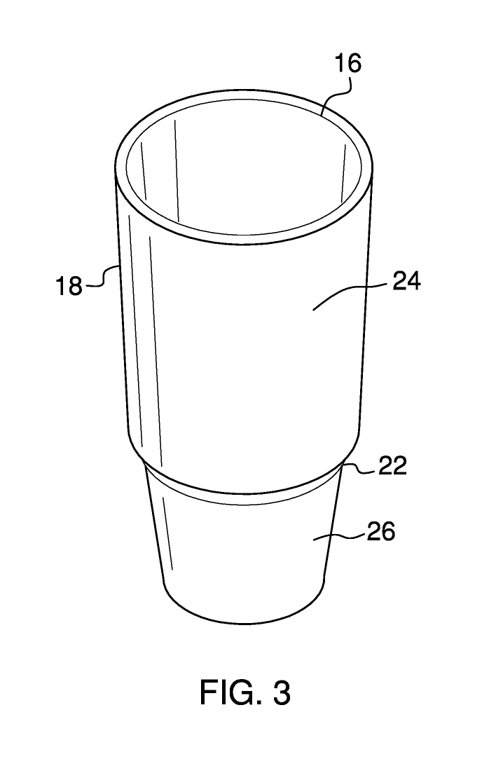

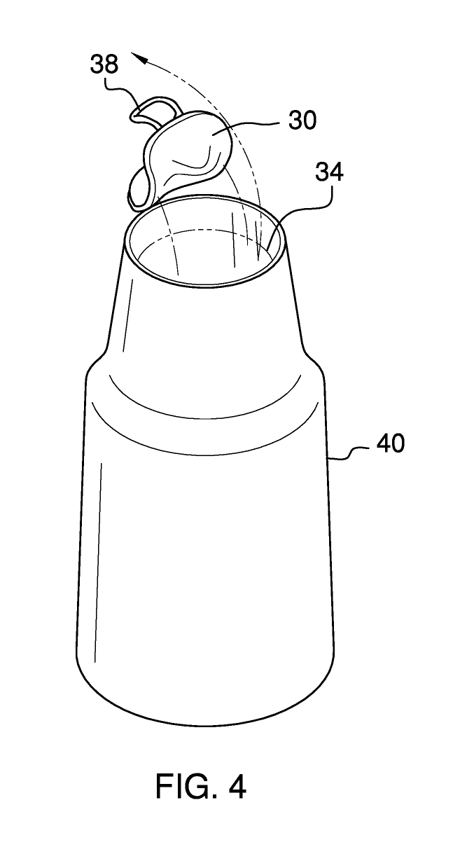

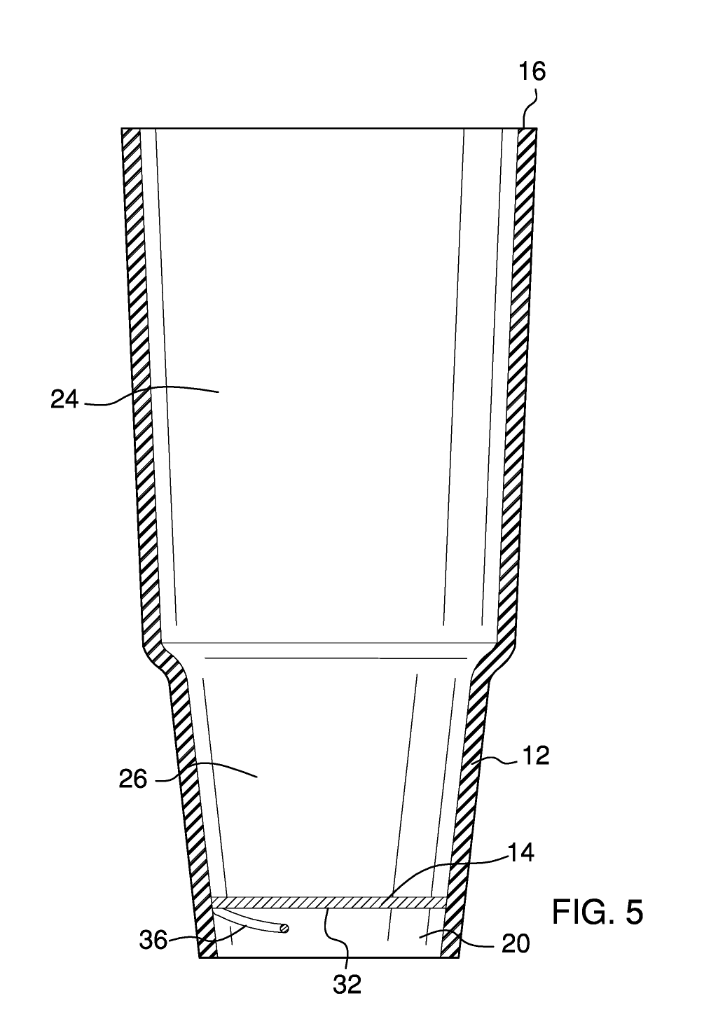

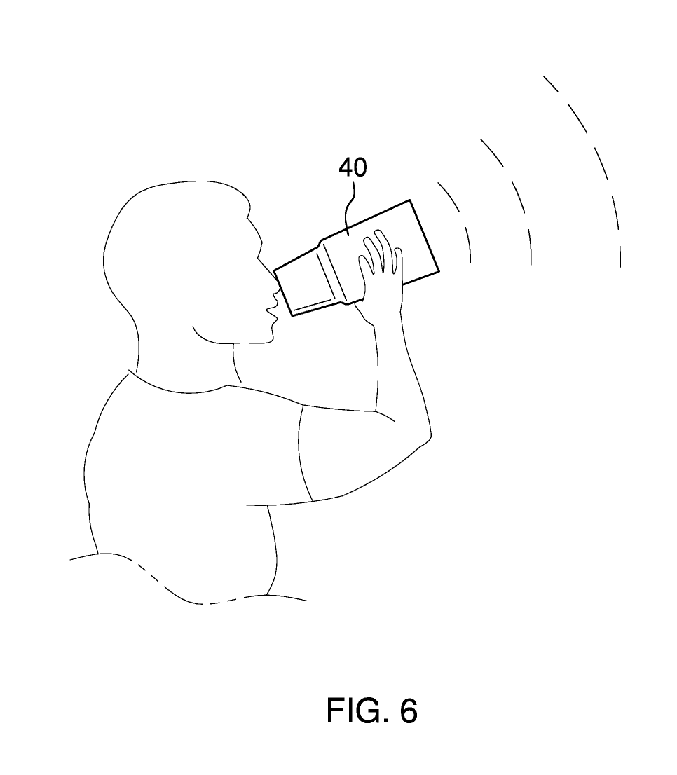

With reference now to the drawings, and in particular to FIGS. 1 through 6 thereof, a new cup embodying the principles and concepts of an embodiment of the disclosure and generally designated by the reference numeral 10 will be described.

As best illustrated in FIGS. 1 through 6, the removable bottom cup 10 generally comprises an annular wall 12 that extends from a bottom 14 to a top 16. The top 16 is open. The bottom 14 and the annular wall 12 define a vessel 18. The vessel 18 is configured to position a consumable item. In one embodiment, the bottom 14 and the top 16 are substantially circular. In another embodiment, the top 16 is dimensionally larger than the bottom 14. In yet another embodiment, the annual wall 12 is conically shaped. In still yet another embodiment, the annular wall 12 extends past the bottom 14 and defines an inset 20. In still yet another embodiment, the annular wall 12 and the bottom 14 comprises plastic.

A recess 22 is positioned in the annular wall 12 and defines an upper section 24 and a lower section 26 of the vessel 18. The lower section 26 is circumferentially complementary to a standard holder for a beverage container.

A plurality of perforations 28 is positioned in the bottom 14. The perforations 28 are interconnected and define a removable section 30 of the bottom 14. The perforations 28 are configured to separate so that the removable section 30 is selectively detachable from the bottom 14. The vessel 18 is reconfigured to use as a megaphone 40.

In one embodiment, the perforations 28 are partial so that the vessel 18 is configured to position a beverage. In another embodiment, the perforations 28 extend into the bottom 14 from a lower face 32 of the bottom 14. In yet another embodiment, the perforations 28 are positioned around a circumference 34 of the bottom 14. In this embodiment, the removable section 30 is dimensionally equivalent to the bottom 14.

A tab 36 is flexibly coupled to the lower face 32 of the removable section 30. The tab 36 is configured to position transverse to the removable section 30. The tab 36 is configured to grasp and pull. In one embodiment, the tab 36 comprises a ring 38 such that at least of portion of a digit on a hand of a user is insertable into the ring 38. In another embodiment, the ring 38 is substantially squarely shaped.

In use, the vessel 18 is configured to position a consumable item. The tab 36 is configured to position transverse to the removable section 30. The tab 36 is configured to grasp and pull. The perforations 28 are configured to separate. The removable section 30 is detached from the bottom 14. The vessel 18 is reconfigured to use as the megaphone 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. Removable bottom cup comprising:
an annular wall extending from a bottom to a top, said top being open;
a plurality of perforations positioned in said bottom, said perforations being interconnected defining a removable section of said bottom;
a tab flexibly coupled to a lower face of said removable section; and
wherein said bottom and said annular wall define a vessel such that said vessel is configured for positioning of a consumable item wherein said tab is positioned on said removable section such that said tab is configured for positioning transverse to said removable section, such that said tab is configured for grasping and pulling, wherein said perforations are configured for separating such that said removable section is detached from said bottom, such that said vessel is reconfigured for using as a megaphone.

2. The cup of claim 1, further including said bottom and said top being substantially circular.

3. The cup of claim 1, further including said top being dimensionally larger than said bottom such that said annual wall is conically shaped.

4. The cup of claim 1, further including said annular wall extending past said bottom defining an inset.

5. The cup of claim 1, further including said annular wall and said bottom comprising plastic.

6. The cup of claim 2, further including a recess positioned in said annular wall defining an upper section and a lower section of said vessel, wherein said recess is positioned in said annular wall such that said lower section is circumferentially complementary to a standard holder for a beverage container.

7. The cup of claim 1, further including said perforations being partial such that said vessel is configured for positioning of a beverage.

8. The cup of claim 1, further including said perforations extending into said bottom from said lower face of said bottom.

9. The cup of claim 1, further including said perforations being positioned around a circumference of said bottom such that said removable section is dimensionally equivalent to said bottom.

10. The cup of claim 1, further including said tab comprising a ring such that at least of portion of a digit on a hand of a user is insertable into said ring.

11. The cup of claim 10, further including said ring being substantially squarely shaped.

12. Removable bottom cup comprising:
an annular wall extending from a bottom to a top, said top being open, wherein said bottom and said annular wall define a vessel such that said vessel is configured for positioning of a consumable item, said bottom and said top being substantially circular, said top being dimensionally larger than said bottom such that said annual wall is conically shaped, said annular wall extending past said bottom defining an inset, said annular wall and said bottom comprising plastic;
a recess positioned in said annular wall defining an upper section and a lower section of said vessel, wherein said recess is positioned in said annular wall such that said lower section is circumferentially complementary to a standard holder for a beverage container;
a plurality of perforations positioned in said bottom, said perforations being interconnected defining a removable section of said bottom, wherein said perforations are configured for separating such that said removable section is selectively detachable from said bottom such that said vessel is reconfigured for using as a megaphone, said perforations being partial such that said vessel is configured for positioning of a beverage, said perforations extending into said bottom from a lower face of said bottom, said perforations being positioned around a circumference of said bottom such that said removable section is dimensionally equivalent to said bottom;
a tab flexibly coupled to said lower face of said removable section, wherein said tab is positioned on said removable section such that said tab is configured for positioning transverse to said removable section, such that said tab is configured for grasping and pulling, said tab comprising a ring such that at least of portion of a digit on a hand of a user is insertable into said ring, said ring being substantially squarely shaped; and
wherein said vessel is configured for positioning of a consumable item, wherein said tab is positioned on said removable section such that said tab is configured for positioning transverse to said removable section, such that said tab is configured for grasping and pulling, wherein said perforations are configured for separating such that said removable section is detached from said bottom, such that said vessel is reconfigured for using as said megaphone.
